(19) United States
(12) Patent Application Publication
(10) Pub. No.: US 2011/0297666 A1
(43) Pub. Date: Dec. 8, 2011

(54) Heating Apparatus and Method for Producing the Heating Apparatus

(75) Inventors: Jan Ihle, Grambach (AT); Wemer Kahr, Deutschlandsberg (AT); Volker Wischnat, Deutschlandsberg (AT)

(73) Assignee: EPCOS AG, Munich (DE)

(21) Appl. No.: 13/002,934

(22) PCT Filed: Jul. 3, 2009
(86) PCT No.: PCT/EP2009/058421

§ 371 Date: Apr. 7, 2011

(30) Foreign Application Priority Data
Jul. 10, 2008 (DE) 10 2008 032 509.0

(51) Int. Cl. H05B 3/02; H01C 17/02

(52) U.S. Cl. 219/538; 29/611

(57) ABSTRACT

A heating apparatus and a method for producing a heating apparatus are specified. The heating apparatus comprises a pipe (10), which is suitable for conducting a medium and has an outer surface, and at least one injection-molded shaped body on the outer surface of the pipe (10). The shaped body comprises a material with a positive temperature coefficient of electrical resistance and is adapted to the outer surface of the pipe (10).

The invention relates to a heating apparatus and a method for producing the heating apparatus.

Media, for example fluids, can be heated by means of a thermal contact with materials having a positive temperature coefficient of electrical resistance (PTC materials). Hitherto, such PTC materials have been able to be shaped as disks or rectangular elements. If the medium is not in direct contact with the PTC material, but rather is situated in a container or housing, reduced contact areas between the PTC materials and the housings can be present if the housings or containers have curved surfaces. A small contact area between the PTC material and the housing results in a low efficiency on account of the unfavorable surface area/volume ratio. To date, round pipes through which fluids flow, for example have been able to be heated by means of PTC materials only with a low efficiency. This brings about longer heating times and higher heating powers.

One object to be achieved consists in providing a heating apparatus having a high efficiency. This object is achieved by means of a heating apparatus in accordance with patent claim 1. Further patent claims relate to further embodiments of the apparatus and to a method for producing said apparatus.

In accordance with one embodiment, a heating apparatus is provided, comprising a pipe having an outer surface, said pipe being suitable for conducting a medium, and at least one injection-molded shaped body on the outer surface of the pipe. In this case, the shaped body is adapted with regard to its form to the outer surface of the pipe and comprises a material with a positive temperature coefficient of electrical resistance.

A heating apparatus, which can be used for example as a continuous-flow heater, is thus provided which efficiently heats a medium conducted through the pipe. As a result of a voltage being applied to the shaped body, the latter is heated on account of its positive temperature coefficient of electrical resistance, and can emit this heat to the pipe. In this case, the shaped body has a self-regulating behavior. If the temperature in the shaped body reaches a critical value, the resistance in the shaped body also rises, such that less current flows through the shaped body. Further heating of the shaped body is thus prevented, as a result of which no additional electronic regulation of the heating power need be provided. With this heating apparatus, the medium conducted through the pipe can be heated indirectly by the shaped body.

The use of an injection-molded shaped body makes it possible to improve the efficiency of the heating apparatus in comparison with conventional heating apparatuses since the pipe, independently of the form of the outer surface, is in thermal contact with the shaped body over a large area and a favorable surface area/volume ratio is thus present.

Furthermore, there is no direct contact between the medium to be heated that is conducted by the pipe and the shaped body. It is thus possible to prevent the shaped body from being corrosively attacked by a medium to be heated or from being dissolved by the medium, and/or to prevent the material of the shaped body from contaminating the medium to be heated.

The pipe of the heating apparatus can furthermore have an outer surface which comprises a curvature at least in partial regions. It is therefore possible to use cylindrical pipes, pipes having an oval cross section or further pipes shaped in any desired fashion, which can be shaped symmetrically or asymmetrically and the curvature of which can also be interrupted by a bend.

The use of the different geometrical forms of the pipes is made possible by the use of an injection-molded shaped body fitted on the outer surface of the pipe. The pipe can furthermore have any desired length, for example a length of 5 to 10 cm, to which the injection-molded shaped body is adapted. The diameter of a pipe, if a cylindrical form is chosen, for example can likewise be chosen as desired, for example with a size of up to 5 mm. The pipe can have a wall thickness chosen such that the mechanical strength of the pipe is ensured, and the heat of the shaped body can readily be conducted through the walls of the pipe. A wall thickness can be, for example, less than 1 mm or less than ½ mm. The ratio of the length of the pipe to the diameter of the pipe can be chosen such that the throughflow time for the medium through the pipe is long enough for the medium to be heated uniformly in the vicinity of the inner side of the pipe and also in the center of the pipe.

The pipe can comprise a material which is thermally highly conductive. The material can be selected from a group comprising metals and also electrically insulating materials. Electrically insulating materials can simultaneously be highly thermally conductive. By way of example, aluminum oxide or aluminum nitride can be chosen as material for the pipe. If, instead of a metal, an electrically insulating material is chosen for the pipe, it is possible, in the case of applications appertaining to power supply system voltage, for example, to achieve electrical insulation in order to avoid a potential-carrying medium. The use of aluminum oxide as material for the pipe leads to a highly thermally conductive pipe which is inert toward acid and bases and is also food-compatible with respect to media which must not be contaminated.

The at least one shaped body and the pipe can be in thermal contact with one another. Furthermore, a thermally conductive paste can be arranged between the pipe and the at least one shaped body. In both cases, a good thermal contact between the pipe and the shaped body is ensured, such that the heat transfer between the shaped body and the pipe is optimized. The heat transfer is furthermore improved by the form of the injection-molded shaped body adapted to the pipe, since a large-area thermal contact between the shaped body and the pipe is present.

The connection between the pipe and the shaped body can be positively locking and elastic. In order to obtain an elastic connection between pipe and shaped body, a thermally conductive paste is arranged between the pipe and the shaped body. A material comprising particles incorporated into polymers can be chosen for the thermally conductive paste. The particles can comprise, for example, thermally conductive metal particles or aluminum oxide particles. Said particles provide for a good thermal conductivity of the paste arranged between the shaped body and the pipe.

An elastic connection between the shaped body and the pipe compensates for possible changes in volume of the pipe and/or of the shaped body which can occur during the change in temperature in the course of the heating process, such that mechanical stresses between pipe and shaped body and/or stress cracks of the pipe or of the shaped body are avoided.

The at least one shaped body can furthermore extend in a longitudinal direction. The shaped body thus has a longitudinal extension. Therefore, the pipe, along its longitudinal axis, can be surrounded by the at least one shaped body completely or at least over a large area since said shaped body is adapted to the longitudinal extension of the pipe. Consequently, large regions of the pipe are thermally contacted by the shaped body and heated when a voltage is applied to the shaped body.

The shaped body can be fixed to the pipe by means of a clamp or by means of an adhesive. When an adhesive is used, a plastic adhesive connection can be chosen in order to avoid thermally induced stress cracks which could occur as a result of changes in volume of the materials of the shaped body, of the pipe or of the adhesive. Furthermore, clamps and adhesive can also simultaneously be used for fixing the shaped body to the pipe.

The adhesive can be arranged between the pipe and the shaped body. It can be fitted on the pipe or on an inner side of the shaped body.

The adhesive can comprise a material selected from a group comprising adhesives based on epoxides, polyamides and silicones. These materials can furthermore comprise silver and/or nickel and/or aluminum oxide powder, which improve the thermal conductivity of the adhesive.

The pipe can have a cylindrical outer surface and the at least one shaped body can be adapted to the outer surface in a positively locking manner. A positively locking adaptation reduces air gaps between pipe and shaped body, such that a good thermal contact between pipe and shaped body is present.

Furthermore, along the circumferential direction of the pipe, a plurality of shaped bodies can be arranged on the outer surface of said pipe. Consequently, by way of example, half-shell-type shaped bodies can be arranged on opposite sides of a cylindrical pipe. Furthermore, quarters or even smaller partial regions of the pipe can also be covered by a respective shaped body and a plurality of shaped bodies strung together can thus cover the pipe in the direction of the circumferential direction. Shaped bodies can also be arranged on the pipe one behind another, in the longitudinal direction of the pipe, such that longer pipes are also covered by shaped bodies.

Furthermore, a plurality of pipes can be arranged in a parallel fashion alongside one another, and can be surrounded by shaped bodies. In this case, an integral configuration is conceivable in which a single shaped body is adapted to the pipes arranged in a parallel fashion, or in which a plurality of shaped bodies are configured such that they surround a multiplicity of pipes. By way of example, interlinked half-shells can be configured as shaped bodies into which pipes are placed and a matching counterpart can be arranged on interlinked half-shells on the other side of the pipes. Alternatively, individual pipes surrounded by shaped bodies can also be arranged alongside one another.

The pipe can be suitable for conducting fluids. Fluids conducted through the pipe can thus be heated in the pipe. A fluid can comprise gases and liquids, for example water. Gels or powders can likewise be conducted through the pipe. The shaped body can have electrical contact-connections for generating a current flow. In this case, a contact-connection comprises an electrode fitted to the shaped body, and also a contact element, which can be electrically conductively connected to the electrode and to an external electrical contact. In order to form two electrodes, by way of example, the inner and outer surfaces of the shaped body can be metalized. The inner metalization, which constitutes one of the electrodes, can be electrically contact-connected to an outer contact by means of a contact element, for example an angular contact plate. For this purpose, a cutout for the arrangement of the contact plate is then provided in the shaped body. The contact plate can be led out from the interspace between the pipe and the shaped body on an end side of the pipe or at an end side of the shaped body. The outer metalization, which constitutes the second electrode, can be electrically contact-connected for example by a clamp fixed to the pipe on the outside.

If two or more shaped bodies are arranged at the pipe, the individual shaped bodies can have end sides which can be metalized. The individual metalized end sides can then be electrically contact-connected by means of a contact element. Furthermore, the end sides of a single shaped body adapted to a pipe can also be metalized and contact-connected by means of contact elements.

The shaped body can have a wall thickness selected from a range comprising 0.1 mm to 3 mm. The wall thickness of the shaped body is selected depending on the configuration of the electrodes and depending on the voltage applied to the electrodes. Furthermore, the wall thickness of the shaped body can be selected depending on the distance between the electrodes fitted to the shaped body. Consequently, it is possible to set the ohmic resistance in the shaped body depending on the arrangement and configuration of the electrodes and the wall thickness of the shaped body.

By way of example, the distance between the electrodes in the case of applications appertaining to power supply system voltage can be 2 mm. Depending on the size of the pipe, the distance between the electrodes can also be larger.

If the electrodes are fitted to end sides of shaped bodies and have a distance of 2 mm, the wall thickness of the shaped bodies can be 0.2 mm, for example.

Furthermore, the heating apparatus can have a plastic injection-molded housing that thermally insulates the heating apparatus. The pipe can have at its ends regions suitable for connection to a line system for the medium that is to be conducted and heated. Said regions can comprise hard-soldered metal rings, for example, which are soldered onto the line system, which leads to an impermeable connection between the heating apparatus and the line system.

The shaped body of the heating apparatus can contain a ceramic material having the structure Ba_{l-x-y}MₓD_{y}Ti_{l-a-b}NₐMn_{b}O₃.

The structure comprises a perovskite structure. In this case, x comprises the range 0 to 0.5, y comprises the range 0 to 0.01, a comprises the range 0 to 0.01, b comprises the range 0 to 0.01, M comprises a divalent cation, D comprises a trivalent or tetravalent donor and N comprises a pentavalent or hexavalent cation. M can be, for example, calcium, strontium or lead; D can be, for example, yttrium or lanthanum. Examples of N are niobium or antimony. The shaped body can comprise metallic impurities present with a content of less than 10 ppm. The content of metallic impurities is so low that the PTC properties of the shaped body are not influenced.

Said material can have a Curie temperature comprising a range of −30° C. to 340° C. The material of the shaped body can furthermore have a resistance at 25° C. which lies in a range of 3 Ωcm to 30 Ωcm.

Furthermore, a method for producing a heating apparatus having the properties mentioned above is provided. The method comprises the following method steps:
A) providing a pipe having an outer surface,
B) injection-molding the at least one shaped body having a form adapted to the outer surface of the pipe,
C) sintering the shaped body,
D) arranging electrodes on the shaped body,
E) assembling and fixing the at least one shaped body and the pipe.

In this case, in method step B), the shaped body is adapted to the outer surface of the pipe in a manner taking account of the shrinkage of the shaped body. Depending on the composition of the material for the shaped body, shrinkage of the volume of the shaped body can occur during sintering in method step C). Consequently, in method step B), a shaped body is injection-molded which prior to sintering has a form which is too large for the pipe to which the shaped body is adapted, and after sintering is adapted to the pipe.

A method is thus provided in which a shaped body is adapted to a provided pipe by said shaped body being injection-molded, such that a large thermal contact area between pipe and shaped body is ensured. The individually produced and provided parts, the pipe and the at least one shaped body, can be fixed to one another by means of clamps or adhesives.

Furthermore, in method step B), for the production of the shaped body, a ceramic starting material is provided which comprises a ceramic filling material having the structure Ba_{l-x-y}MₓD_{y}Ti_{l-a-b}NₐMn_{b}O₃ and a matrix.

In order to produce the ceramic starting material with metallic impurities amounting to less than 10 ppm, it can be produced using tools which have a hard coating in order to avoid abrasion. A hard coating can consist of tungsten carbide, for example. All surfaces of the tools which come into contact with the ceramic material can be coated with the hard coating.

In this way, a ceramic filling material that can be converted into a ceramic PTC material by sintering can be mixed with a matrix and processed to form granules. Said granules can be injection-molded for further processing to form the shaped body.

The matrix into which the ceramic filling material is incorporated and which has a lower melting point than the ceramic material can in this case have a proportion of less than 20% by mass relative to the ceramic material. The matrix can comprise a material selected from a group comprising wax, resins, thermoplastics and water-soluble polymers. Further additives such as antioxidants or plasticizers can likewise be present.

Method step B) can comprise the steps of:

B1) providing the ceramic starting material,
B2) injection-molding the starting material into a shape, and
B3) removing the matrix.

During sintering in method step C), the ceramic starting material is converted into the material of the shaped body having a positive temperature coefficient of electrical resistance.

The subjects described will be explained in even greater detail on the basis of the figures and exemplary embodiments:

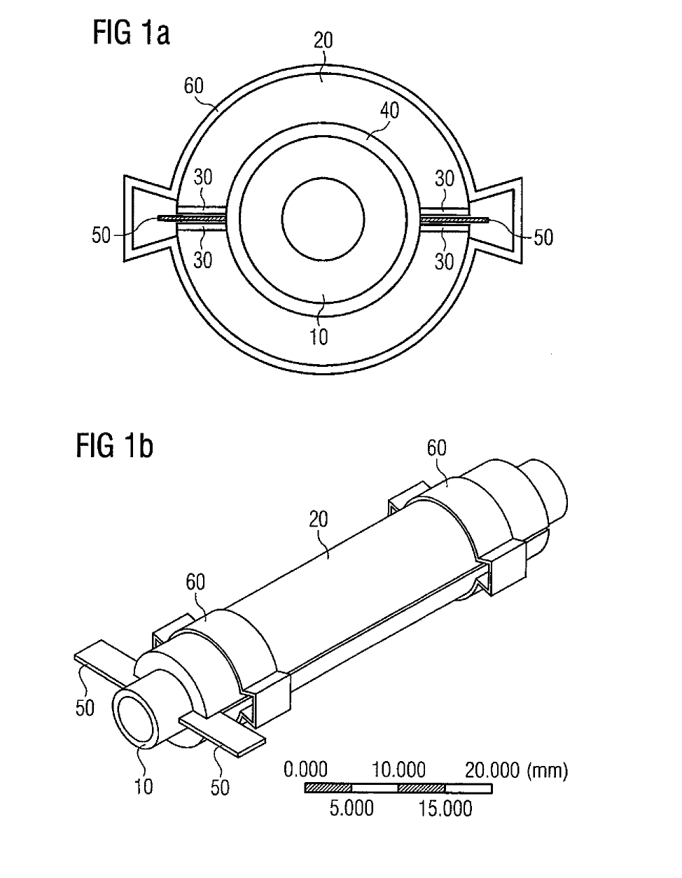

FIG. 1a shows a first embodiment of the heating apparatus in schematic side view,

FIG. 1b shows the first embodiment of the heating apparatus in schematic three-dimensional view,

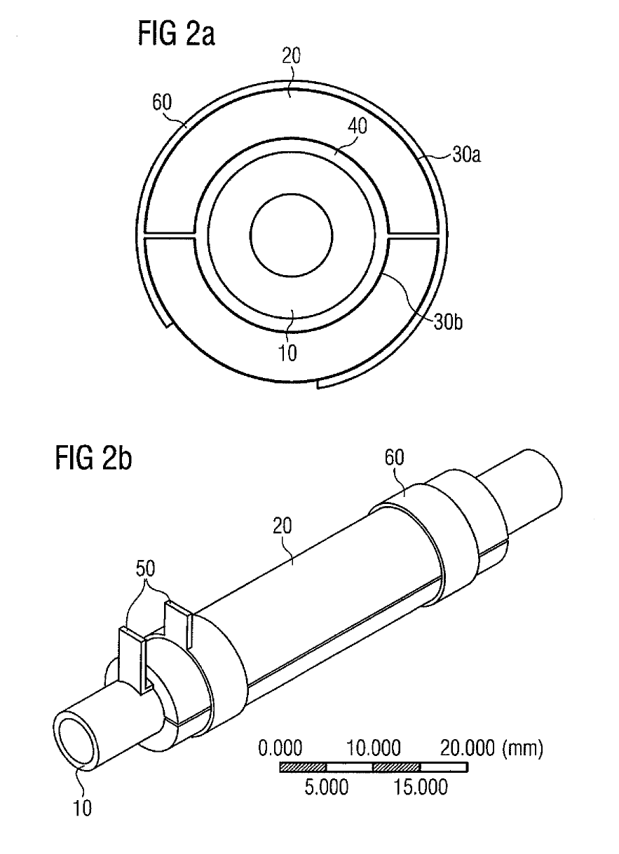

FIG. 2a shows a second embodiment of the heating apparatus in schematic side view,

FIG. 2b shows the second embodiment of the heating apparatus in schematic three-dimensional view,

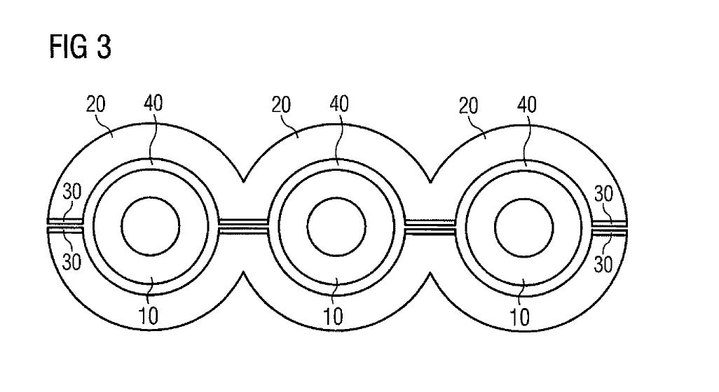

FIG. 3 shows a third embodiment of the heating apparatus in schematic side view.

FIG. 1a shows the schematic cross section of the side view of a first embodiment of the heating apparatus. The pipe 10 is surrounded by a thermally conductive paste 40, on which two shaped bodies 20 configured as half-shells are arranged. The pipe 10 has a cylindrical form to which the shaped bodies 20 are adapted in a positively locking manner. The thermally conductive paste 40 can comprise a polymer into which thermally conductive particles are incorporated. The pipe 10 can consist of a thermally conductive material, for example aluminum oxide. The shaped bodies 20 have a positive temperature coefficient of electrical resistance and contain a material having the structure Ba_{l-x-y}MₓD_{y}Ti_{l-a-b}NₐMn_{b}O₃.

Electrodes 30 are present at the end sides of the shaped bodies 20, which electrodes can be electrically contact-connected externally by means of contact elements 50. The shaped bodies 20 are fixed to the pipe 10 by means of a clamp 60. Alternatively or additionally, the shaped bodies 20 can also be fixed to the pipe 10 by means of an adhesive (not shown here). A medium can be conducted within the pipe 10, which medium can be heated indirectly by the PTC effect of the shaped bodies 20 when a voltage is applied. The heating process begins as soon as a current flow is generated in the shaped bodies 20 as a result of the electrical contact-connection.

FIG. 1b shows a three-dimensional schematic view of the embodiment from FIG. 1a. Here, too, the shaped bodies 20 can be seen, as can the clamps 60 and the electrical contact elements 50. Furthermore, exposed regions of the pipe 10 are present, which regions can be connected to a line system for conducting a\medium.

FIG. 2a shows a further schematic side view of an embodiment of the heating apparatus. Once again a thermally conductive paste 40 is arranged on the pipe 10. Two half-shell-type shaped bodies 20 are present on the paste. Here, the inner and outer surfaces of the shaped bodies 20 are metalized. These metalizations in each case constitute an electrode 30. The outer electrode 30a, the metalization on the outer surface of the shaped body, is electrically contact-connected externally through a cutout in the clamp 60. The inner electrode 30b can likewise be contact-connected externally by a contact element, for example an angular contact plate (not shown here).

FIG. 2b shows the schematic view of the embodiment from FIG. 2a in three-dimensional form. The contact elements 50 that make contact with the outer and inner electrodes 30a and 30b can be seen here. The electrical contact-connection is effected via the end side of the pipe.

As a result of the different arrangement of the electrodes 30 in FIGS. 1 and 2, the direction of the current flow in the shaped bodies is different. While in the embodiment in FIG. 1 the current flow through the shaped body 20 runs parallel to the outer surface of the pipe 10, the current flow in the embodiment in accordance with FIG. 2 runs perpendicularly to the outer surface of the pipe 10. It can be shown in simulations that particularly the embodiment in FIG. 1 achieves a high heating power in conjunction with a small thickness of the shaped body.

FIG. 3 shows a further schematic side view of an embodiment of the heating apparatus. Here, three pipes 10 each surrounded by a thermally conductive paste 40 are arranged alongside one another and parallel to one another. Two shaped bodies 20 adapted in a positively locking fashion to the pipes 10 arranged in a parallel fashion are arranged on two sides of the pipes. The contact-connection of the shaped bodies 20 can be effected analogously to the exemplary embodiment from FIG. 1 or from FIG. 2. FIG. 3 shows, by way of example, electrodes 30 at the end sides of the shaped bodies. Contact elements 50 for making electrical contact with the shaped bodies, and clamps 60 for fixing the shaped bodies 20 to the pipes 10 are not shown in this figure, for the sake of clarity.

The embodiments shown in the figures can be varied in any desired manner. It should furthermore be taken into account that the invention is not restricted to the examples, but rather permits further configurations not presented here.

List of Reference Symbols
10 Pipe
20 Shaped body
30 Electrode
30a Outer electrode
30b Inner electrode
40 Paste
50 Contact element
60 Clamp

1. A heating apparatus, comprising:
a pipe having an outer surface, said pipe being suitable for conducting a medium and at least one injection-molded shaped body on the outer surface of the pipe, wherein the shaped body comprises a material with a positive temperature coefficient of electrical resistance and is adapted to the outer surface of the pipe.

2. The heating apparatus as claimed in claim 1, wherein the outer surface of the pipe has a curvature at least in partial regions.

3. The heating apparatus as claimed in claim 1, wherein the pipe comprises a thermally highly conductive material.

4. The heating apparatus as claimed in claim 1, wherein the at least one shaped body and the pipe are in thermal contact with one another.

5. The heating apparatus as claimed in claim 1, wherein a thermally conductive paste is arranged between the pipe and the at least one shaped body.

6. The heating apparatus as claimed in claim 1, wherein the at least one shaped body has a longitudinal extension.

7. The heating apparatus as claimed in claim 1, wherein the shaped body is fixed to the pipe by means of a clamp or by means of an adhesive.

8. The heating apparatus as claimed in claim 1, wherein the pipe has a cylindrical outer surface, and the at least one shaped body is adapted to the outer surface in a positively locking manner.

9. The heating apparatus as claimed in claim 1, wherein along the circumferential direction of the pipe, a plurality of shaped bodies are arranged on the outer surface of said pipe.

10. The heating apparatus as claimed in claim 1, wherein the pipe are suitable for conducting fluids.

11. The heating apparatus as claimed in claim 1, wherein the shaped body has electrical contact-connections for generating a current flow.

12. The heating apparatus as claimed in claim 1, wherein the at least one shaped body contains a ceramic material having the structure Ba_{l-x-y}MₓD_{y}Ti_{l-a-b}NₐMn_{b}O₃, where x=0 to 0.5, y=0 to 0.01, a=0 to 0.01, b=0 to 0.01, M comprises a divalent cation, D comprises a trivalent or tetravalent donor, and N comprises a pentavalent or hexavalent cation.

13. The heating apparatus as claimed in claim 1, wherein the at least one shaped body has a Curie temperature which comprises a range of −30° C. to 340° C.

14. The heating apparatus as claimed in claim 1, wherein the at least one shaped body has a resistance at 25° C. which lies in a range of 3 Ωcm to 30 000 Ωcm.

15. A method for producing a heating apparatus as claimed in claim 1, comprising the following method steps:
A) providing a pipe having an outer surface;
B) injection-molding an at least one shaped body having a form adapted to the outer surface of the pipe;
C) sintering the shaped body;
D) arranging electrodes on the shaped body; and
E) assembling and fixing the at least one shaped body and the pipe.
